(19) United States
(12) Patent Application Publication
(10) Pub. No.: US 2021/0243822 A1
(43) Pub. Date: Aug. 5, 2021

(54) SYSTEMS AND METHODS FOR WIRELESS SPEAKER COMMUNICATION

(71) Applicant: ENCLAVE AUDIO LIMTED, Wan Chai (HK)

(72) Inventors: Robert JONES, JR., Murrieta, CA (US); Stephen MASCENIK, Torrance, CA (US)

(21) Appl. No.: 17/124,327

(22) Filed: Dec. 16, 2020

Related U.S. Application Data
(60) Provisional application No. 62/948,753, filed on Dec. 16, 2019.

(51) Int. Cl. H04W 76/10; H04R 3/12; H04R 5/04

(52) U.S. Cl. CPC H04W 76/10; H04R 2420/07; H04R 5/04; H04R 3/12

(57) ABSTRACT

Systems and methods for wireless speaker communication are disclosed herein. In one aspect, a method for wirelessly linking a speaker hub with at least one speaker includes: broadcasting by the speaker hub a set of discovery communications; receiving by the speaker hub at least one discovery response from the at least one speaker; determining by the speaker hub a speaker identity of the at least one speaker from the received discovery response; and establishing a wireless data link between the speaker hub and the at least one speaker for audio output for the at least one speaker.

### CROSS-REFERENCE TO RELATED APPLICATION

This application claims the benefit of priority to U.S. Provisional Patent Application Ser. No. 62/948,753, filed Dec. 16, 2019. The entire content of this application is hereby incorporated by reference herein.

### BACKGROUND OF THE INVENTION

Wireless speaker systems can include speakers with ability to wirelessly communicate with other speakers within the systems, thereby allowing for coordination of audio output between speakers as well as the convenience associated with wireless devices (e.g., expansive installation locations, more aesthetically pleasing than wired devices, etc.). Conventional wireless speaker systems rely on an audio/video receiver (AVR) for coordinating and managing audio output for each speaker. Further, conventional wireless speakers rely on a receiver to acquire a compatible signal from a transmitter device. The acquisition of a compatible wireless audio signal conventionally requires user input to associate or “pair” 1 or more speakers in the system. However, these conventional systems often require user input to associate the speakers to the system, which can be complicated and can lead to user error (e.g., incorrect speaker identification, nonoptimal calibration, etc.). Further, conventional AVR systems act as a repeater system, where a conventional AVR receives a digital signal as input and repeats the digital signal as output, such as through an HDMI input/output. In the case of an analog source and analog speakers, the conventional hub will therefore convert the source signal to digital, and then the speakers reconvert the hub's output signal from digital back to an analog signal. These multiple conversions can lead to signal degradation or distortion, which can negatively impact sound quality.

### SUMMARY

Systems and methods for wireless speaker communication are disclosed herein. In one aspect, a method for wirelessly linking a speaker hub with at least one speaker includes: broadcasting by the speaker hub a set of discovery communications; receiving by the speaker hub at least one discovery response from the at least one speaker; determining by the speaker hub a speaker identity of the at least one speaker from the received discovery response; and establishing a wireless data link between the speaker hub and the at least one speaker for audio output for the at least one speaker.

This aspect can have a variety of embodiments. In one embodiment, the method can further include generating an audio output communication for the at least one speaker based on the determined identity; and transmitting the audio output communication to the at least one speaker over the established wireless data link.

In another embodiment, the method can further include determining a task of the at least one speaker based on the received discovery response. In some cases, the task can include a position of the at least one speaker relative to the speaker hub, a defined audio channel the at least one speaker is configured to output, or a combination thereof.

In another embodiment, the method can further include activating power for the speaker hub, where the broadcasting is performed due to the activation.

In another aspect, a speaker system can include a speaker hub adapted or configured to: broadcast a set of discovery communications; receive at least one discovery response from at least one speaker; determine a speaker identity of the at least one speaker from the received discovery response; and establish a wireless data link between the speaker hub and the at least one speaker for audio output for the at least one speaker; and the at least one speaker configured or adapted to: receive at least one of the set of discovery communications; and transmit the discovery response communication in response to the received discovery communication.

This aspect can include a variety of embodiments. In one embodiment, the speaker hub can be further adapted or configured to: generate an audio output communication for the at least one speaker based on the determined identity; and transmit the audio output communication to the at least one speaker over the established wireless data link.

In another embodiment, the speaker hub can be further adapted or configured to determine a task of the at least one speaker based on the received discovery response. In some cases, the task can include a position of the at least one speaker relative to the speaker hub, a defined audio channel the at least one speaker is configured to output, or a combination thereof.

In another embodiment, the speaker hub can be further adapted or configured to implement the broadcasting due to an activation of power for the speaker hub.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 depicts a system for wireless speaker communication according to an embodiment of the claimed invention.

FIG. 2 depicts a hub for a wireless speaker communication according to an embodiment of the claimed invention.

FIG. 3 depicts a speaker for wireless speaker communication according to an embodiment of the claimed invention.

FIG. 4 depicts a process diagram for wireless speaker communication according to an embodiment of the claimed invention.

FIG. 5 depicts perspectives of a speaker hub according to embodiments of the claimed invention.

FIG. 6 depicts perspectives of a speaker according to embodiments of the claimed invention.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

### DETAILED DESCRIPTION OF THE INVENTION

### Speaker System

Embodiments of the claimed invention relate to systems for management and coordination of a group of synchronized wireless speakers. The system can include at least one speaker and a management hub. The speaker can include a unique identifier that can be associated with the management hub. Further, the unique identifier can identify the particular characteristics of the speaker. For example, the unique identifier can include information corresponding to the type of speaker, and/or a particular task of the speaker (e.g., the speaker is a left-front speaker in a 2:1 audio configuration, right-back in a 5:1 configuration, and the like). Once the speaker and the hub are powered on, the hub and the speaker can communicate with one another such that the hub receives identification information of the speaker. The speaker and hub can therefore associate with one another, and initiate audio output of the speaker, without the need for user input. This can reduce user error when setting up the system, for example in mistaking the identity of the speaker.

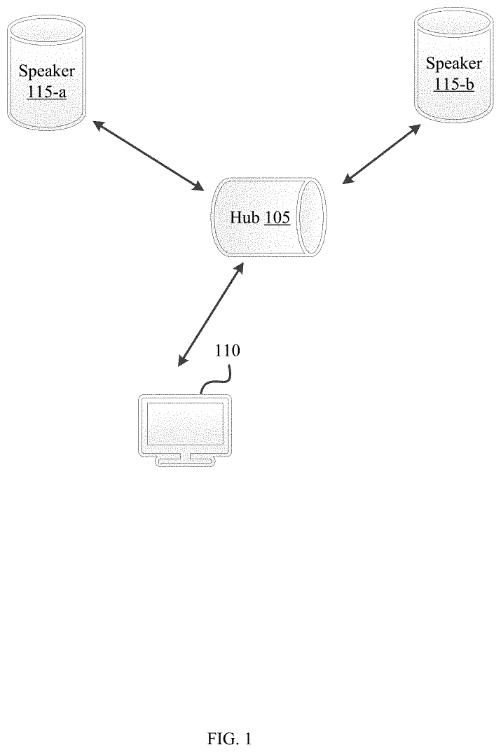

FIG. 1 illustrates a wireless speaker system according to an embodiment of the claimed invention. The system can include a hub 105, an audio source 110, and at least one speaker. FIG. 1 depicts a 2-speaker system (e.g., speakers 115-a and 115-b), however, it should be noted that one skilled in art would understand the system to accommodate any number of speakers, and is not limited to the example depicted in the figure.

The hub 105 can manage and coordinate data communications with the individual speakers in the system. Audio output for each speaker can be dependent upon the audio configuration of the system. For example, in a 5:1 audio configuration, speaker 115-a can output audio differently than it would in a 7:1 configuration. The same logic would apply to different configuration schemes, such as Dolby Digital®, THX®, DTS®, and the like. One skilled in the art would appreciate that the hub 105 can be programmed to implement or execute any of a number of speaker configurations and configuration schemes, and is not limited to the specific examples provided herein.

The hub 105 can automatically connect to the speakers in the system. For example, the hub 105 can broadcast a discovery communication (e.g., a discovery probe) once powered on. The discovery communication can include discovery information, such as an identifier of the hub 105, communication resources to be used for the discovery process (e.g., frequency, bandwidth, and the like), etc. The hub 105 can receive in return discovery responses from the speakers 115-a and 115-b. A discovery response can include identifier information for each speaker, information corresponding to specific tasks or locations for the speaker, and the like. The hub 105 can verify that the speaker is a part of the system (e.g., checking a list of identifiers stored by the hub 105, etc.) and can send an acknowledgement to the speaker. The acknowledgement can indicate to the speaker that the speaker and the hub 105 are now connected. Further, the acknowledgement can indicate various communication details to the speaker, such as frequency and bandwidth for data transmission, frequency and bandwidth for control information, and the like. Thus, a user is not required for connecting the hub 105 to the various speakers within the system. All that is needed from a user is to power on the hub 105 and any speakers desired by the user.

Based on the configuration and configuration scheme (e.g., selected by a user or preprogrammed), the hub 105 can manage and coordinate audio output of the associated speakers in the system. For example, in various configuration schemes, audio output for a given speaker is termed a channel. The hub 105 can manage these channels, and can relay data to a designated channel for future audio output.

### Speaker Hub

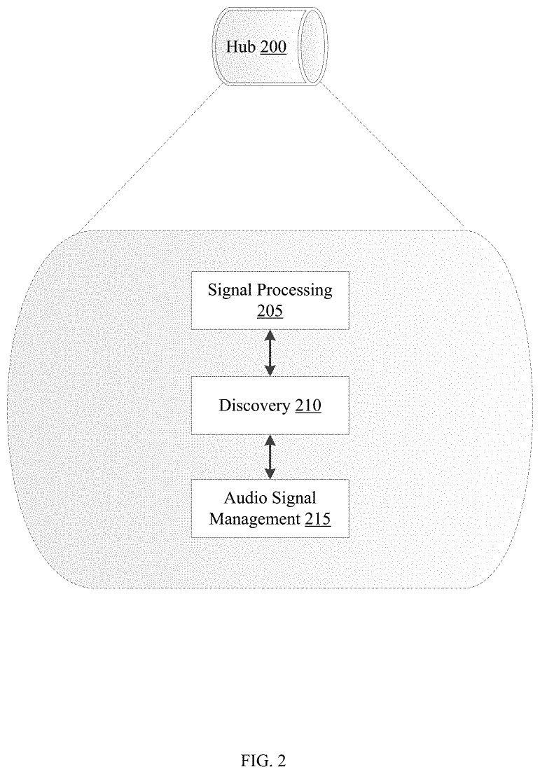

FIG. 2 depicts a hub 200 for wireless speaker communication according to an embodiment of the claimed invention. The hub 200 can be an example of the hub 105 described with reference to FIG. 1.

The hub 200 can include a variety of hardware for implementing the system described above. For example, the hub 200 can include a signal processing module 205 for processing input signals and prepping output signals for a transmission layer (e.g., of a communication protocol). The hub 200 can also include discovery module 210 for managing discovery communications, both received and transmitted. For example, the discovery module 210 can generate discovery communications for transmission via the transmission layer of the hub 200. The discovery communications can include at least an identifier associated with the hub, and in some cases can also include control information such as response communication parameter (e.g., bandwidth, frequency, and the like) for a stereo to utilize in responding. The identifier of the hub can be stored in a lookup table, which can include one or more identifiers of the hub 200. The hub 200 can also include a lookup table (e.g., separate or in unison with the lookup table storing the hub identifiers) storing identifiers for stereos. When a discovery response communication is received from a stereo, the discovery module 210 can compare an identifier of discovery response communication to the identifiers stored in the lookup table. If a match is found, the discovery module 210 can generate an acknowledgment message for transmission to the given speaker.

The hub 105 can also include an audio signal management module 215 for generating and managing audio signals for speakers. For example, the hub 200 can receive audio input from an audio source such as a TV (or directly from the broadcast source, such as via broadband or ethernet connections). The audio signal management module 215 can generate audio signal transmissions for a corresponding linked speaker based on a variety of factors, such as the location of the speaker, a total number of speakers linked with the hub 200, a current number of actively linked speakers with the hub 200, audio channel configurations (e.g., surround sound, etc.), channel quality conditions for the wireless communication links between the speaker(s) and the hub 200, and the like. These audio signal transmissions can be transmitted to a corresponding speaker, which can then output as audio signals.

Further the audio signal management module 215 can also manage parameters of each speaker. Parameters such as audio channel configuration, speaker power output, audio signal transmission parameters (e.g., channel frequency, channel bandwidth, modulation scheme, coding scheme, etc.), and the like, can be stored and managed by the audio signal management module 215. The audio signal management module 215 can also generate control communications for transmission to a corresponding speaker for parameter updates or changes.

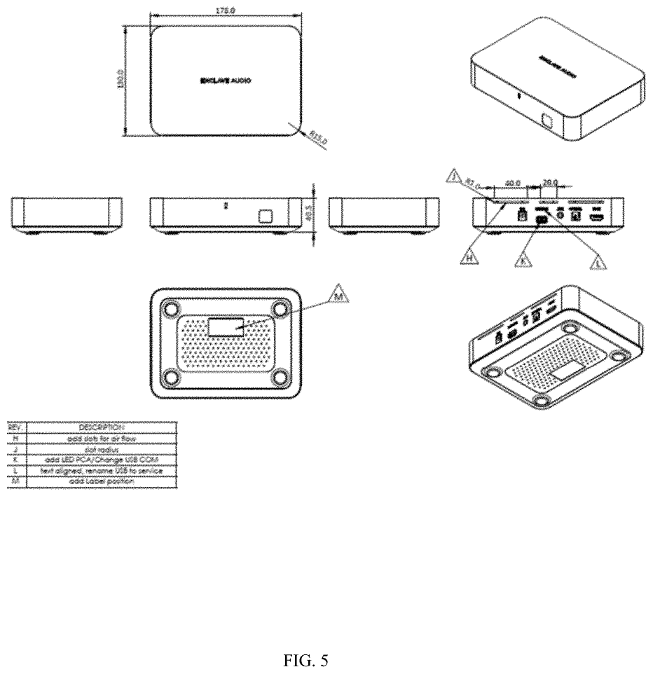

FIG. 5 depicts various perspectives of a speaker hub, such as speaker hub 105 described with reference to FIG. 1.

### ARC

The hub 105 can include an HDMI output slot. The hub 105 can be connected to an HDMI input 110 via the input device's (e.g., a TV) HDMI-ARC slot. Through this HDMI connection, the hub 105 can receive the audio signal from the connected TV using the Audio Return Channel function of the input device and sends the audio signal to a signal processing module, such as the signal processing module mentioned above. Depending on the configuration scheme of the system, the hub 105 can process and in some cases decode the A/V signal received and partition the signal into the designated channels of the configuration. Importantly, use of ARC allows for two benefits. First, as the hub ARC connection acts as input from the input audio source, the ARC connection can minimize the number of input slots for the hub 105. For example, gaming consoles, DVD players, and the like, can be connected to the source input 110 (e.g., a TV), rather than having to connect or reconnect them all to the hub 105. This can increase the plug-and-play ability of the speaker system and reduce cabling required for the acquisition and transmission of audio to the speaker system.

### Hub Filtering and Data Processing

Filtering of inputted signals to the hub 105 can be via the application of audio filters, including crossover filtering, and based on certain and specific speaker identification characteristics present in a speaker configuration file.

### Speakers

The system of FIG. 1 can include a variety of speakers. The speakers 115-a and 115-b can each include its own unique identifier. Further, each speaker 115-a and 115-b can include its own preprogrammed task. For example, speaker 115-a can be programmed to act as the left-back speaker in a 5:1 configuration. The speakers can include a variety of specifications and parameters, including power output, frequency range, signal processors, and the like. The speakers can receive audio input (e.g., which is controlled and managed by) the hub 105 and broadcast the signals as audio.

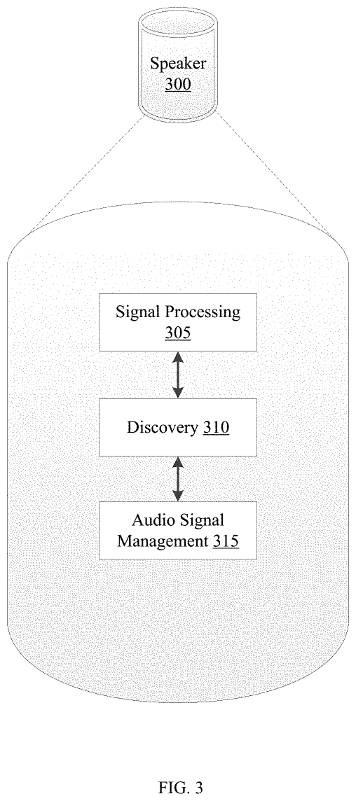

FIG. 3 depicts a speaker 300 according to an embodiment of the claimed invention. The speaker 300 can be an example of speaker 115-a or 115-b discussed with reference to FIG. 1. The speaker 300 can include a signal processing module 305, a discovery module 310, and an audio signal management module 315. The signal processing module 305 can process input signals and prepping output signals for a transmission layer (e.g., of a communication protocol).

The speaker 300 can also include a discovery module 310 for managing discovery communications, both received and transmitted. For example, the discovery module 310 can generate discovery response communications for transmission via the transmission layer of the speaker 300. The discovery response communications can include at least an identifier associated with the speaker 300, and in some cases can also include control information such as an acknowledgement of received controller information. The identifier of the speaker can be stored in a lookup table, which can include one or more identifiers of the speaker 300. In some cases, the speaker 300 can also include a lookup table (e.g., separate or in unison with the lookup table storing the speaker identifiers) for storing identifiers for the corresponding speaker hub. When a discovery communication is received from a hub, the discovery module 310 can compare an identifier contained in the discovery communication to the identifiers stored in the lookup table. If a match is found, the discovery module 310 can generate a discovery response communication for transmission to the hub.

Further the audio signal management module 315 can also manage parameters of the speaker 300. Parameters such as audio channel configuration, speaker power output, audio signal transmission parameters (e.g., channel frequency, channel bandwidth, modulation scheme, coding scheme, etc.), and the like, can be stored and managed by the audio signal management module 315. In some cases, the speaker 300 can receive control transmissions from the corresponding hub with parameter adjustment instructions. The audio signal management module 315 can implement these adjustments for the speaker 300.

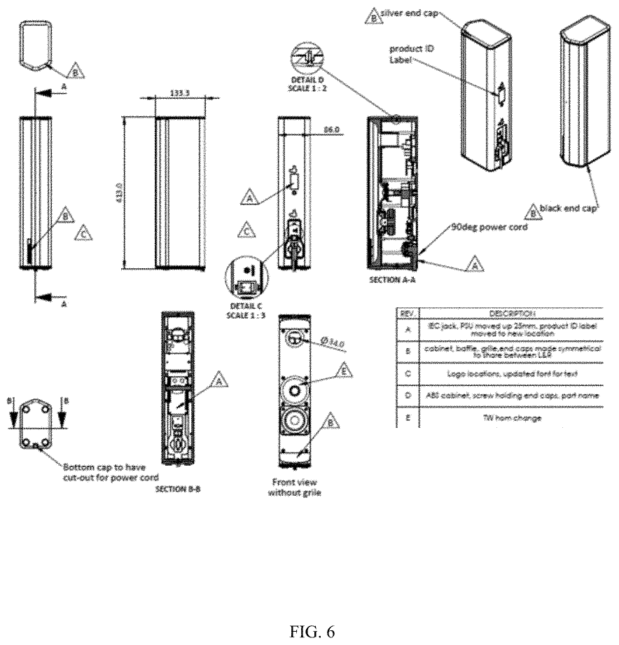

FIG. 6 depicts various perspectives of a speaker for wireless communication, which can be examples of speakers 115-a and 115-b as described with reference to FIG. 1.

### Process Flow

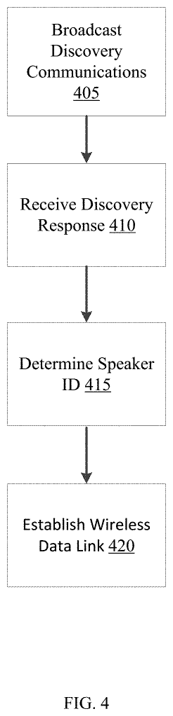

FIG. 4 depicts a process flow for wirelessly linking a speaker hub with at least one speaker, according to an embodiment of the claimed invention. The process flow can be implemented by a speaker hub, such as hub 105 as described with reference to FIG. 1, and/or a speaker, such as speaker 115-a or 115-b with reference to FIG. 1.

At Step 405, a speaker hub can broadcast a set of discovery communications. The discovery communications can in some cases include identifiers corresponding to the speaker hub, control information such as discovery response channel parameters, and the like. In some cases, the discovery communications can be broadcast automatically (e.g., without the need for user input) based on power activation to the speaker hub.

At Step 410, the speaker hub can receive at least one discovery response from at least one speaker. The discovery response can include identifiers corresponding to the responding speaker. The discovery response can in some cases also include other information, such as a speaker task (e.g., specific audio configuration channels the speaker is configured to output), speaker parameters (e.g., power output, frequency range, etc.), and the like.

At Step 415, the speaker hub can determine a speaker identity of the at least one speaker from the received discovery response. The speaker hub can compare the identifier received from the speaker with speaker identifiers stored by the speaker hub (e.g., in a lookup table). If the received identifiers match a stored identifier, the speaker hub can determine the speaker is configured for association with the speaker hub.

At Step 420, a wireless data link can be established between the speaker hub and the speaker. The speaker hub can in some cases transmit an acknowledgement message back to the speaker, which can indicate the speaker is configured for association with the speaker hub. In some cases, the speaker hub can respond to the discovery response with control information for the wireless link (e.g., channel frequency, bandwidth, transmitting power, and the like).

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference.

1. A method for wirelessly linking a speaker hub with at least one speaker, comprising:
broadcasting by the speaker hub a set of discovery communications;
receiving by the speaker hub at least one discovery response from the at least one speaker;
determining by the speaker hub a speaker identity of the at least one speaker from the received discovery response; and
establishing a wireless data link between the speaker hub and the at least one speaker for audio output for the at least one speaker.

2. The method of claim 1, further comprising:
generating an audio output communication for the at least one speaker based on the determined identity; and
transmitting the audio output communication to the at least one speaker over the established wireless data link.

3. The method of claim 1, further comprising:
determining a task of the at least one speaker based on the received discovery response.

4. The method of claim 3, wherein the task comprises a position of the at least one speaker relative to the speaker hub, a defined audio channel the at least one speaker is configured to output, or a combination thereof.

5. The method of claim 1, further comprising:
activating power for the speaker hub, wherein the broadcasting is performed due to the activation.

6. A speaker system comprising:
a speaker hub adapted or configured to:
broadcast a set of discovery communications;
receive at least one discovery response from at least one speaker;
determine a speaker identity of the at least one speaker from the received discovery response; and
establish a wireless data link between the speaker hub and the at least one speaker for audio output for the at least one speaker; and
the at least one speaker configured or adapted to:
receive at least one of the set of discovery communications; and
transmit the discovery response communication in response to the received discovery communication.

7. The speaker system of claim 6, wherein the speaker hub is further adapted or configured to:
generate an audio output communication for the at least one speaker based on the determined identity; and
transmit the audio output communication to the at least one speaker over the established wireless data link.

8. The speaker system of claim 6, wherein the speaker hub is further adapted or configured to determine a task of the at least one speaker based on the received discovery response.

9. The speaker system of claim 8, wherein the task comprises a position of the at least one speaker relative to the speaker hub, a defined audio channel the at least one speaker is configured to output, or a combination thereof.

10. The speaker system of claim 6, wherein the speaker hub is further adapted or configured to implement the broadcasting due to an activation of power for the speaker hub.
